(19) United States
(12) Patent Application Publication
(10) Pub. No.: US 2010/0090554 A1
(43) Pub. Date: Apr. 15, 2010

(54) OUTER-ROTOR BRUSHLESS MOTOR

(76) Inventors: Tadashi YANO, Ueda-shi (JP); Akihito FUKUZAWA, Ueda-shi (JP)

Correspondence Address: BIRCH STEWART KOLASCH & BIRCH, PO BOX 747, FALLS CHURCH, VA, 22040-0747, US

(21) Appl. No.: 12/578,881

(22) Filed: Oct. 14, 2009

(30) Foreign Application Priority Data
Oct. 15, 2008 (JP) 2008-266458

(51) Int. Cl. H02K 21/22

(52) U.S. Cl. 310/156.01

(57) ABSTRACT

An outer-rotor brushless motor is smaller, flatter, and lighter but has no drop in motor performance. A motor substrate on which a motor driving circuit is formed is fixed to a bracket in a space formed in the axial direction between (i) a rotor and a stator and (ii) an opening bottom portion of the bracket.

### CROSS-REFERENCE TO RELATED APPLICATIONS

This application is based upon and claims the benefit of priority of the prior Japanese Patent Application No. 2008-266458, filed on 15 Oct. 2008, the entire contents of which are incorporated herein by reference.

### FIELD

The present invention relates to an outer-rotor brushless motor used for example in a vehicle air conditioner, a battery cooling apparatus, and the like.

### BACKGROUND

As one example, an outer-rotor blower motor (DC brushless motor) used as the driving apparatus of a vehicle air-conditioner will now be described with reference to FIG. 3.

A stator (not illustrated) is fixed to a motor holder 51 and an output shaft 52 is rotatably supported by a bearing portion. Although not illustrated, a rotor, constructed with magnets attached to the inner circumferential surface of a cup-shaped rotor yoke, is attached to the output shaft 52 so as to surround the stator.

A fan (impeller) 53 is attached to one end of the output shaft 52. The other end of the output shaft 52 extends to a lower case 54 that covers the motor holder 51. A motor substrate 55 is housed between the motor holder 51 and the lower case 54. A driving circuit (excitation circuit) for a DC brushless motor is provided on the motor substrate 55.

An output transistor (switching element) 56 such as a FET that switches an excitation current is provided on the motor substrate 55, and a heat sink (radiator) 57 that is exposed to the outside from the motor holder 51 is assembled so as to contact heat-generating components such as the output transistor 56. The heat that is transferred to the heat sink 57 from the heat-generating components such as the output transistor 56 is dissipated into the atmosphere by a cooling air-flow generated by rotation of the fan 53 (see Patent Document 1).

### Patent Document 1

Japanese Laid-Open Patent Publication No. H11-332203

### SUMMARY

However, for an outer-rotor brushless motor, in addition to the thickness of the stator core and rotor, there is also the thickness of the motor substrate 55 on which the motor driving circuit is formed, which means that the motor construction tends to be considerably thick in the axial direction.

In particular, since the heat sink (radiator) 57, which is exposed to the outside of the motor holder 51 from inside the lower case 54, is assembled so as to contact the heat-generating components such as the output transistor 56, sufficient space is required in the axial direction for the heat transfer path composed of the heat sink 57. Also, since electronic components (as examples, an electrolytic capacitor 58 and a choke coil) that require a comparatively high space are disposed on the motor substrate 55, the space taken up by components tends to increase in the axial direction.

Also, since a motor provided in a vehicle needs to be sufficiently water-resistant to prevent damage to the driving circuit during salt spray testing, a cover (the lower case 54) is provided to cover and protect the motor substrate 55, which also increases the thickness of the motor in the axial direction.

Also, although the number of electronic components used in vehicles, such as module components and substrate-mounted electronic components such as sensors, motors, and the like, is increasing to improve comfort, safety, and environmental performance, environmental concerns also call for reductions in overall vehicle weight, which means that components like motors also need to be made smaller and lighter.

In this way, although the number of electronic components used in vehicles is increasing, to reduce the space required for installation in a vehicle, there is a strong demand for a motor that is flatter (i.e., slimmer) in the axial direction with no drop in motor performance.

The present invention was conceived to solve the problems described above and it is an object of the present invention to provide an outer-rotor brushless motor that is smaller, flatter, and lighter but has no drop in motor performance.

To achieve the stated object, an outer-rotor brushless motor according to the present invention includes: a rotor including a rotor yoke; a stator disposed inside a space surrounded by the rotor yoke; and a closed motor case which is produced by attaching a cup-shaped bracket so as to cover an attachment base and which houses the rotor and the stator, wherein a motor substrate, on which a motor driving circuit is formed, is fixed adjacent to an opening bottom portion of the bracket in a space formed in an axial direction between (i) the rotor and the stator and (ii) the opening bottom portion of the bracket.

The rotor yoke of the rotor may be cup-shaped, magnets may be provided on an inner circumferential surface of the rotor yoke, the rotor may be coupled to a motor shaft in a center of a rotor yoke opening, and the rotor may be rotatably attached to the bracket by supporting the motor shaft using a bearing portion erected in the center of the bracket opening with the rotor yoke opening facing the opening bottom portion of the bracket so as to surround the stator which is attached to the bearing portion.

Electronic components that are comparatively high may be disposed on the motor substrate in one of a first area close to the center in the radial direction of the opening bottom portion of the bracket and a second area close to the outer edge on the outside of the rotor yoke in the radial direction and electronic components that generate a large amount of heat may be disposed adjacent to the opening bottom portion of the bracket in an intermediate region between the first area and the second area.

The bracket and the attachment base may be sealed with a seal member in between.

The outer-rotor brushless motor may be a fan motor for use in a vehicle and may have a fan attached to an end portion of the motor shaft that extends out of the bracket.

By using the outer-rotor brushless motor described above, since the motor substrate is fixed both adjacent to the opening bottom portion of the bracket and within a range in the axial direction that is inside the motor case surrounded and sealed by the bracket and the attachment base that construct the exterior of the motor, it is possible to miniaturize and flatten the motor in the axial direction and to reduce the weight.

The rotor may be rotatably assembled with the rotor yoke opening facing the opening bottom portion so as to surround the stator which is attached to the bearing portion of the bracket. Since the stator is disposed in a space formed by housing the rotor yoke inside the bracket opening so that the rotor yoke opening faces the opening bottom portion, it is possible to reduce the height of the motor in the axial direction in spite of the motor being an outer-rotor motor.

If electronic components that are comparatively high are disposed on the motor substrate in one of a first area close to the center in the radial direction of the opening bottom portion of the bracket and a second area close to the outer edge on the outside of the rotor yoke in the radial direction and electronic components that generate a large amount of heat are disposed adjacent to the opening bottom portion of the bracket in an intermediate region between the first area and the second area, it will be possible to dispose the substrate-mounted components inside the bracket opening using the free space on both sides of the substrate, and therefore it is possible to dispose the motor substrate adjacent to the bracket and miniaturize the motor.

In addition, since it is possible to electrically connect the bracket and the motor substrate to ground the bracket, by removing the static electricity generated in the bearing portion, it is possible to avoid electrical corrosion and improve the durability.

Also, since the bracket and the attachment base may be sealed with a seal member in between, it is possible to provide an outer-rotor brushless motor that is sufficiently water-resistant and vibration-proof to withstand an extreme usage environment.

Also, for a fan motor for use in a vehicle where a fan is attached to an end portion of the motor shaft that extends out of the bracket, it is possible to direct a cooling air-flow onto the bracket that is right next to the fan in the axial direction and cool the bracket. This means it is possible to efficiently dissipate the heat from the heat-generating components mounted on the motor substrate and the heat generated by the magnet wires via the entire surface of the bracket.

### BRIEF DESCRIPTION OF DRAWINGS

FIG. 1 is a schematic view (half in cross-section) of an outer-rotor brushless motor to which a fan has been attached;

FIG. 2 is a cross-sectional schematic view of an outer-rotor brushless motor from which the fan has been removed; and

FIG. 3 is a schematic view (half in cross-section) of a conventional outer-rotor motor.

### DESCRIPTION OF EMBODIMENTS

A preferred embodiment of an outer-rotor brushless motor will now be described with reference to the attached drawings. The present embodiment will be described by way of a fan motor (i.e., an outer-rotor DC brushless motor) for use in a vehicle.

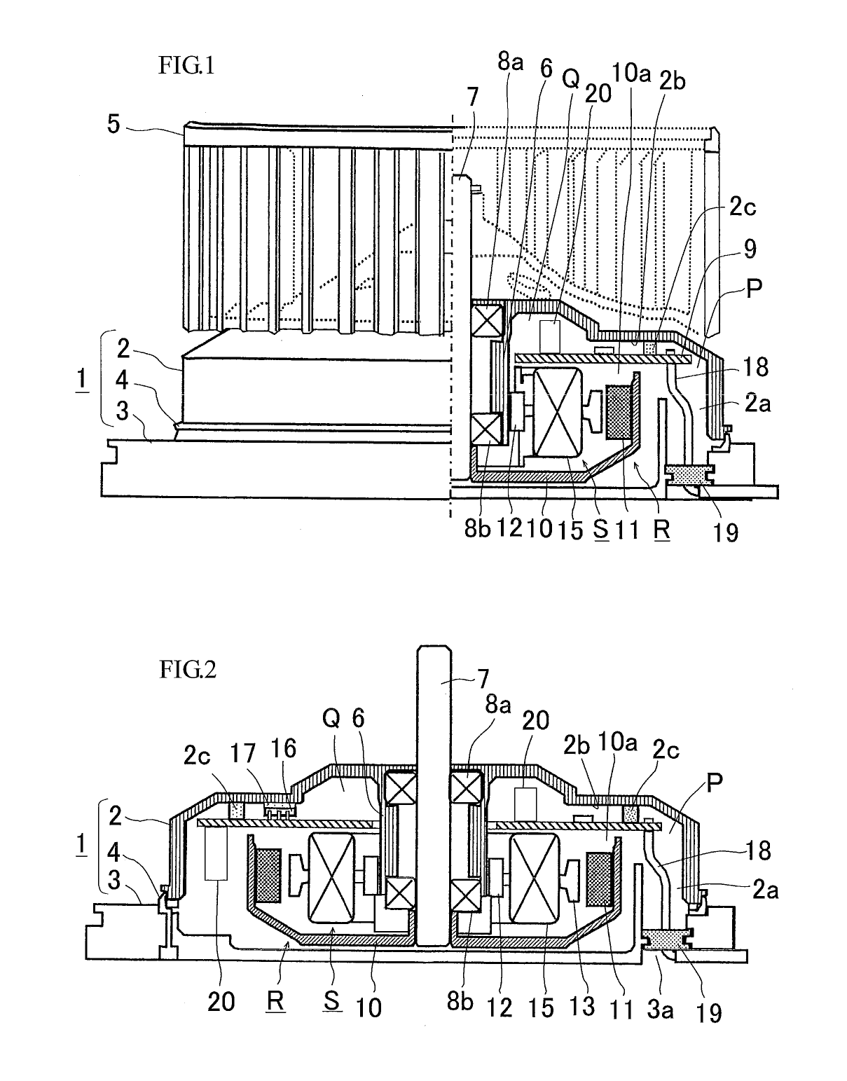

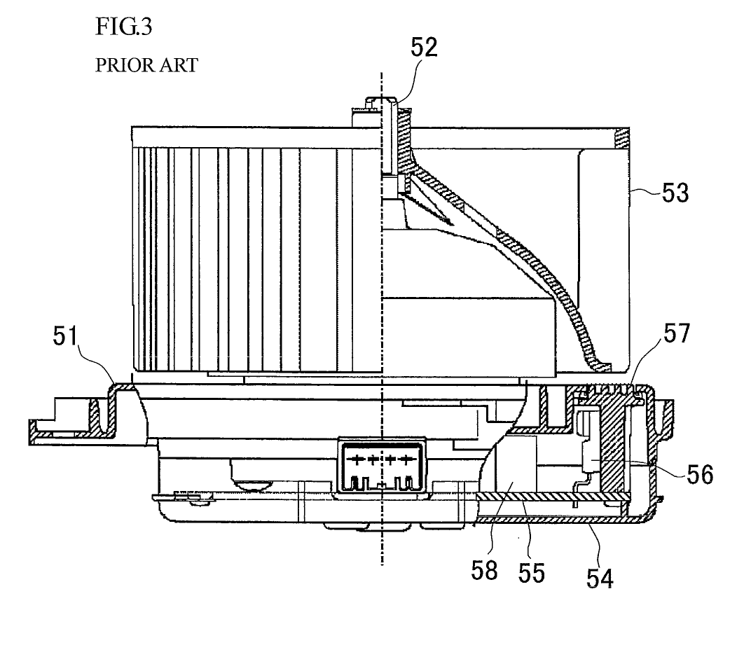

The overall construction of an outer-rotor DC brushless motor will now be described with reference to FIGS. 1 and 2.

As depicted in the left half of FIG. 1, a DC brushless motor 1 is produced by integrally assembling a cup-shaped bracket 2 and an attachment base 3 with a seal member (made, for example, of an elastic resin material such as an elastomer) 4 in between. A fan (impeller) 5 is integrally attached to one end of a motor shaft, described later, in the periphery of the bracket 2. When the fan 5 rotates, air is drawn from a central part in the axial direction and expelled outward.

As depicted in the right half of FIG. 1, a hollow cylindrical portion 6 is provided so as to protrude into the center of a bracket opening 2a of the cup-shaped bracket 2. Inside the hollow cylindrical portion 6, a motor shaft 7 is rotatably supported via bearing portions (ball bearings, sleeve bearings, or the like) 8a, 8b. The bracket 2 serves as both the rotor bearing portion and the motor case. Aside from an aluminum die-cast product (foundry product) that is lightweight and favorably dissipates heat, it is possible to use cold-rolled steel sheet (SPCC) or the like. A rotor R and a stator S are housed inside a closed space P that is closed by forming the bracket 2, which constructs the exterior of the motor, so as to cover the attachment base 3 with the seal member 4 in between.

Also, a motor substrate (PWB) 9 on which a motor driving circuit is formed is fixed in a space Q formed in the axial direction between (i) the rotor R and the stator S and (ii) an opening bottom portion 2b of the bracket 2 by being screwed to screw holes of boss portions 2c provided at a plurality of positions on the opening bottom portion 2b. Since the motor substrate 9 can be fixed both adjacent to the opening bottom portion 2b of the bracket 2 and within a range in the axial direction that is inside the motor case surrounded by the bracket 2 and the attachment base 3 that construct the exterior of the motor, it is possible to miniaturize and flatten the DC brushless motor 1 in the axial direction and to reduce the weight of the blower motor 1. It is also possible to electrically connect the bracket 2 and the motor substrate 9 via the boss portions 2c and/or the screws (not illustrated) and thereby connect the bracket 2 to earth. By doing so, electrical corrosion of the bearing portions 8a, 8b provided in the hollow cylindrical portion 6 is prevented, thereby improving durability. Note that although the motor substrate 9 may be fixed to the hollow cylindrical portion 6, to prevent vibration at an outer edge portion of the substrate, fixing the motor substrate 9 at the outer edge portion thereof is preferable. Also, the motor substrate 9 does not need to be directly attached to the bracket 2 and may be fixed using screws or the like to an insulator of the stator S that is attached to the hollow cylindrical portion 6.

Magnets 11 are joined with adhesive to an inner circumferential surface of a cup-shaped rotor yoke 10 of the rotor R. A center portion of the rotor yoke 10 and the other end of the motor shaft 7 are integrally combined. The rotor R is rotatably assembled on the bracket 2 with a rotor yoke opening 10a facing the opening bottom portion 2b of the bracket 2 and with the motor shaft 7 supported via the bearing portions 8a, 8b on the hollow cylindrical portion 6 formed on the opening bottom portion 2b of the bracket 2. Since the stator S is disposed in a space formed by housing the rotor yoke 10 inside the bracket opening 2a so that the rotor yoke opening 10a faces the opening bottom portion 2b, it is possible to reduce the height of the DC brushless motor 1 in the axial direction in spite of the DC brushless motor 1 being an outer-rotor motor.

In FIG. 2, a ring-shaped stator core 12 is attached onto an outer circumferential surface of the hollow cylindrical portion 6 that is formed on the opening bottom portion 2b of the bracket 2. Teeth portions 13 are provided on the stator core 12 so as to point inward in the radial direction and each tooth portion 13 is insulated by being covered with an insulator, not illustrated. Magnet wire 15 is wound around each tooth portion 13.

In FIG. 2, electronic components (as examples, a choke coil and an electrolytic capacitor 20) that are comparatively high are disposed on the motor substrate 9 in a free space formed in the bracket opening 2a either close to the center in the radial direction of the opening bottom portion 2b or close to the outer edge on the outside of the rotor yoke 10 in the radial direction. Electronic components that generate a large amount of heat (for example, a switching element such as a FET) are disposed in an intermediate region (a region where the boss portions 2c are formed) where the motor substrate 9 is adjacent to the opening bottom portion 2b. By doing so, it is possible to accommodate the height of the substrate-mounted components in the axial direction using the free space inside the bracket opening 2a on both sides of the substrate, which makes it possible to further flatten the motor (i.e., to make the motor slimmer).

Out of the electronic components mounted on the motor substrate 9, the FET 16 contacts the bracket 2 (i.e., the opening bottom portion 2b) via a heat-dissipating silicone member (an oil compound, rubber member, gel member, or the like) 17.

By doing so, heat from the heat-generating component (the FET 16) can be directly transferred to the bracket 2 via the heat-dissipating silicone member 17 and the heat generated by the other mounted components can be efficiently dissipated via the bracket 2 that is adjacent to the motor substrate 9. Even if heat is transferred to the bracket 2, the rotation of the fan 5 will produce a cooling air-flow that is incident on the entire bracket 2, and therefore such heat can be efficiently dissipated.

By fixing the motor substrate 9 adjacent to the bracket 2, motor vibrations can be absorbed by the seal member 4, which makes it possible to protect the wiring connections. In addition, by connecting the bracket to earth on the substrate-side, it is possible to connect the bearing portions (i.e., bearings or the like) to earth and thereby prevent electrical corrosion.

External wiring 18 is connected to the motor substrate 9. The external wiring 18 extends outside the motor via a grommet 19 that is fitted into a through-hole 3a provided in the attachment base 3. By including an earth wire in the external wiring 18, it is also possible to externally ground the motor substrate 9.

As described above, since the motor substrate 9 is disposed within the area of the opening bottom portion 2b of the bracket opening 2a and within a range in the height in the axial direction inside the case that is sealed and surrounded by the bracket 2 and the attachment base 3, it is possible to miniaturize and flatten the motor in the axial direction and to reduce the weight of the motor.

For an outer-rotor brushless motor with an output of around 50 W, for example, it is possible to achieve a reduction in the dimension between the bracket 2 and the attachment base 3 in the axial direction to around half and a reduction in weight to between around ⅔ and ½.

Since the bracket 2 and the attachment base 3 are sealed using the seal member 4, it is possible to provide a motor that is sufficiently water-resistant and vibration-proof to withstand an extreme usage environment where the motor is fitted in a vehicle.

Although a fan motor that is mounted in a vehicle is described in the above embodiment, the present invention is not limited to such, and it is also possible to apply the present invention to apparatuses aside from an air conditioner. Also, the present invention is not limited to a fan motor and can also be applied to a geared motor where a gear is provided at the output end of the motor shaft 6.

What is claimed is:

1. An outer-rotor brushless motor comprising:
a rotor including a rotor yoke;
a stator disposed inside a space surrounded by the rotor yoke; and
a closed motor case which is produced by attaching a cup-shaped bracket so as to cover an attachment base and which houses the rotor and the stator,
wherein a motor substrate, on which a motor driving circuit is formed, is fixed adjacent to the bracket in a space formed in an axial direction between (i) the rotor and the stator and (ii) an opening bottom portion of the bracket.

2. An outer-rotor brushless motor according to claim 1,
wherein the rotor yoke of the rotor is cup-shaped, magnets are provided on an inner circumferential surface of the rotor yoke, the rotor is coupled to a motor shaft in a center of a rotor yoke opening, and the rotor is rotatably attached to the bracket by supporting the motor shaft using a bearing portion erected in the center of the bracket opening with the rotor yoke opening facing the opening bottom portion of the bracket so as to surround the stator which is attached to the bearing portion.

3. An outer-rotor brushless motor according to claim 1,
wherein electronic components that are comparatively high are disposed on the motor substrate in one of a first area close to the center in the radial direction of the opening bottom portion of the bracket and a second area close to the outer edge on the outside of the rotor yoke in the radial direction and electronic components that generate a large amount of heat are disposed adjacent to the opening bottom portion of the bracket in an intermediate region between the first area and the second area.

4. An outer-rotor brushless motor according to claim 1,
wherein the bracket and the attachment base are sealed with a seal member in between.

5. An outer-rotor brushless motor according to claim 1,
wherein the outer-rotor brushless motor is a fan motor for use in a vehicle and has a fan attached to an end portion of the motor shaft that extends out of the bracket.
